(19) United States
(12) Patent Application Publication
(10) Pub. No.: US 2024/0204197 A1
(43) Pub. Date: Jun. 20, 2024

(54) CATHODE COMPOSITION

(71) Applicant: Talga Technologies Limited, Cambridge (GB)

(72) Inventors: Claudio CAPIGLIA, Osaka (JP); Sai SHIVAREDDY, Cambridge (GB); Fengming LIU, Reading (GB); Bruce Seung LEE, Cambridgeshire (GB); Anna Moisala MOTTA, Cambridge (GB); Karanveer Singh ANEJA, Northstowe, Cambridge (GB)

(21) Appl. No.: 18/572,842

(22) PCT Filed: Jun. 30, 2022
(86) PCT No.: PCT/IB2022/056091

§ 371 Date: Dec. 21, 2023

(30) Foreign Application Priority Data
Jun. 30, 2021 (AU) 2021901988

(51) Int. Cl. H01M 4/62; C01B 32/225; H01M 4/02; H01M 4/525; H01M 10/0525

(52) U.S. Cl. CPC H01M 4/625; C01B 32/225; H01M 4/525; H01M 10/0525; C01P 2002/72; C01P 2004/32; C01P 2004/50; C01P 2006/10; C01P 2006/12; C01P 2006/40; C01P 2006/80; H01M 2004/021

(57) ABSTRACT

A cathode composition, the cathode comprising a graphitic material additive, wherein the graphitic material additive comprises graphitic particles having a generally non-spheroidal form and a D₅₀ of less than about 15 μm. A method of producing a graphitic material additive for use in a cathode composition is also disclosed.

### FIELD OF THE INVENTION

The present invention relates to a cathode composition and a method of producing same. More particularly, the cathode composition of the present invention is intended to provide high capacity and high retention thereof.

In particular, the cathode composition of the present invention is intended for use in lithium-ion batteries.

### BACKGROUND ART

Presently, conductive carbon materials are used in lithium-ion batteries in an effort to improve the electrical conductivity of electrochemically active material in both the anodes and cathodes thereof. Carbon black (CB) is the most commonly used conductive additive, whilst commercially available graphite (for example TIMREX® KS 6 from Imerys Graphite & Carbon) is also utilised, as are carbon nanotubes (CNT) and vapour grown carbon fibres (VGCF).

In addition to improving electrical conductivity, carbon black is also understood to minimise heat generation within the battery cell.

CNT have a unique one-dimensional structure and provides what are known to be excellent mechanical, electrical and electrochemical properties. VGCF similarly provides an effective conductive network within the active material coating, which contributes to improved low temperature performance, longer cycle life, higher rate capability and lower volume expansion in the cell. Both CNT and VGCF are considered significant conductive additives—needing only very small loadings (<1%) to provide high conductivity, when compared with carbon black. Unfortunately, both CNT and VGCF are comparatively expensive (by tens of $/kg) and have significant safety concerns associated with their application (CNT in particular prompts an asbestos-like reaction in the lungs).

There would be significant advantage and benefit to providing an improved additive for lithium-ion battery cathodes, particularly an additive derived from a natural graphite precursor.

The cathode composition and method of the present invention have as one object thereof to overcome substantially one or more of the abovementioned problems associated with prior art processes, or to at least provide a useful alternative thereto.

The preceding discussion of the background art is intended to facilitate an understanding of the present invention only. This discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Throughout the specification and claims, unless the context requires otherwise, the term “oblate spheroid” or variations thereof refer to a surface of revolution obtained by rotating an ellipse about its minor axis. Put simply, an oblate spheroid is understood to be a flattened sphere, in which it is wider than it is high. Other terms that are to be understood to indicate substantially that same shape/form are “ellipsoidal” and “potato shaped”.

Throughout the specification and claims, unless the context requires otherwise, the term “flake” or variations thereof, is to be understood to indicate that the material referred to has a flake or flaky morphology or form.

Throughout the specification and claims, unless the context requires otherwise, references to “milling” are to be understood to include reference to “grinding”, and references to “grinding” are to be understood to include reference to “milling”.

Throughout the specification and claims, unless the context requires otherwise, D₅₀ is to be understood to refer to the median value of the particle size distribution. Put another way, it is the value of the particle diameter at 50% in a cumulative distribution. For example, if the D₅₀ of a sample is a value X, 50% of the particles in that sample are smaller than the value X, and 50% of the particles in that sample are larger than the value X.

The term “relative” or “relatively” used in respect of a feature of the invention is intended to indicate comparison to that feature in the prior art and the typical characteristics of that feature in the prior art, unless the context clearly indicates or requires otherwise.

It is to be understood that the ranges provided herein include the stated range and any value or sub-range within the stated range. For example, a range from about 1 micrometer (μm) to about 2 μm, or about 1 μm to 2 μm, should be interpreted to include not only the explicitly recited limits of from between from about 1 μm to about 2 μm, but also to include individual values, such as about 1.2 μm, about 1.5 μm, about 1.8 μm, etc., and sub-ranges, such as from about 1.1 μm to about 1.9 μm, from about 1.25 μm to about 1.75 μm, etc. Furthermore, when “about” and/or “substantially” are/is utilised to describe a value, they are meant to encompass minor variations (up to +/−10%) from the stated value.

### DISCLOSURE OF THE INVENTION

In accordance with the present invention there is provided a cathode composition, the cathode comprising a graphitic material additive, wherein the graphitic material additive comprises graphitic particles having a generally non-spheroidal form and a D₅₀ of less than about 15 μm.

Preferably, the graphitic particles have a D₅₀ of less than about 10 μm.

The non-spheroidal form of the graphitic particles preferably encompasses a form that approximates either an oblate spheroid or a flake form.

Still preferably, the graphitic particles have a carbon content of:
(i) greater than 99.9% wt/wt; or
(ii) greater than 99.92% wt/wt.

The graphitic particles preferably comprise either an agglomerated fines product or a high surface area (HSA) product.

Preferably, the agglomerated fines product comprises secondary graphite particles that predominantly have a form that approximates an oblate spheroid.

In one form of the present invention, the secondary graphite particles have a D₅₀ of:
(i) less than about 5 μm; or
(ii) less than about 2 μm.

Preferably, the secondary graphite particles have a surface area of:
(i) about 2 to 60 m²/g; or
(ii) about 2 to 6 m²/g.

The compression density of the secondary graphite particles at 75 kf/cm² is preferably in the range of about 1.0 to 1.5 g/cc.

The conductivity of the secondary graphite particles is preferably in the range of about 25 to 37 S/cm, for example about 31 S/cm.

Preferably, the secondary graphite particles comprise ground primary graphite particles.

Preferably, the HSA product comprises graphitic particles that have been subject to mechanical exfoliation. Mechanical exfoliation is preferably performed by way of milling, impact, pressure and/or shear forces.

Still preferably, the mechanical exfoliation is conducted:
(i) at greater than 200 kWh/t;
(ii) in the range of 200 to 500 kWh/t;
(iii) at greater than 400 kWh/t;
(iv) in the range of 400 to 500 kWh/t;
(v) at greater than 700 kWh/t;
(vi) in the range of 700 to 1200 kWh/t; or
(vii) in the range of 1000 to 1200 kWh/t.

The graphitic particles of the HSA product preferably have a surface area of:
(i) greater than 20 m²/g;
(ii) in the range of 20 to 40 m²/g;
(iii) in the range of 25 to 35 m²/g;
(iv) greater than 40 m²/g;
(v) in the range of 40 to 80 m²/g; or
(vi) in the range of 40 to 50 m²/g.

In one form of the present invention the graphitic particles of the HSA product have been subject to mechanical exfoliation at greater than 200 kWh/t, for example in the range of 400 to 500 kWh/t, and have a surface area of greater than 20 m²/g, for example 25 to 35 m²/g.

In a further form of the present invention the graphitic particles of the HSA product have been subject to mechanical exfoliation at greater than 700 kWh/t, for example in the range of 1000 to 1200 kWh/t, and have a surface area of greater than 40 m²/g, for example 40 to 50 m²/g.

Preferably, the HSA product has a flake form.

The HSA product is preferably also subjected, after mechanical exfoliation, to drying methods that support the retention of its flake form, for example a cryogenic drying method.

Still preferably, the ground primary graphite particles further comprise a carbon-based material. The carbon-based material is preferably one or more of pitch, polyethylene oxide and polyvinyl oxide.

Preferably, the amount of carbon-based material in the secondary graphite particles is in the range of 2 to 10 wt % relative to graphite.

The ground primary graphite particles preferably have a D₅₀:
(i) of less than 15 μm;
(ii) of less than 10 μm; or
(iii) in the range of about 0.5 to 6 μm.

Preferably, the ground primary graphite particles have a surface area of about 2 to 60 m²/g, for example 7 to 9 m²/g.

Preferably, the ground primary graphite particles have XRD characteristics of one or more of a d002 of >3.35 Å, an Lc of >1000 Å and an La of >1000 Å. In a preferred form, the ground primary graphite particles have XRD characteristics of each of a d002 of >3.35 Å, an Lc of >1000 Å and an La of >1000 Å, and a purity of >99.9%.

In one form, the secondary graphite particle of the graphitic material additive comprises an aggregate of primary graphite particles, the aggregate providing the approximate oblate spheroid form and having a D₅₀ of less than about 5 microns.

The secondary graphite particles may, in one form of the invention, have a D₅₀ of less than about 2 microns.

In one form, the graphitic material additive is derived from a natural graphite precursor.

In accordance with the present invention there is further provided a cathode composition comprising a cathode active material, a graphitic material additive, and a binder, wherein the graphitic material additive comprises graphitic particles having a generally non-spheroidal form and a D₅₀ of less than about 15 μm.

Preferably, the graphitic particles have a D₅₀ of less than about 10 μm.

The non-spheroidal form of the graphitic particles preferably encompasses a form that approximates either an oblate spheroid or a flake form.

In one form of the invention the cathode active material may be provided in the form of lithium cobalt oxide (LCO). In a further form the cathode active material may be provided in the form of nickel manganese cobalt (NMC).

In another form, the binder may be provided in the form of polyvinylidene fluoride (PVdF).

In accordance with the present invention there is further provided a lithium-ion battery comprising a cathode composition as described hereinabove.

In accordance with the present invention there is still further provided a method for producing a cathode composition as described hereinabove.

In accordance with the present invention there is yet still further provided a method of producing a graphitic material additive for use in a cathode composition, the graphitic material additive having a generally non-spheroidal form and a D₅₀ of less than about 15 μm, the method comprising the steps of:
(i) Concentrating and purifying a graphite ore to provide primary graphitic particles having a carbon content of greater than 99.9% wt/wt;
(ii) Classifying the concentrated and purified graphitic particles of step
(i) to produce graphite fines;
(iii) Passing the graphite fines of step (ii) to either:
   i. a coating/mixing step followed by a shaping step to produce a coated primary graphite particle, being an agglomerated fines product; or
   ii. a mechanical exfoliation step to increase the surface area of the graphite fines, producing a high surface area (HSA) product, and from which the graphite fines are passed to a drying step, the drying step being one that retains the HSA product in a flake form.

Preferably, the graphitic particles have a D₅₀ of less than about 10 μm.

The mechanical exfoliation step is preferably performed by way of milling, impact, pressure and/or shear forces.

Still preferably, the mechanical exfoliation step is conducted:
(i) at greater than 200 kWh/t;
(ii) in the range of 200 to 500 kWh/t;
(iii) at greater than 400 kWh/t;
(iv) in the range of 400 to 500 kWh/t;
(v) at greater than 700 kWh/t;
(vi) in the range of 700 to 1200 kWh/t; or
(vii) in the range of 1000 to 1200 kWh/t.

The graphitic particles of the HSA product preferably have a surface area of:
(i) greater than 20 m²/g;
(ii) in the range of 20 to 40 m²/g;
(iii) in the range of 25 to 35 m²/g;
(iv) greater than 40 m²/g;
(v) in the range of 40 to 80 m²/g; or
(vi) in the range of 40 to 50 m²/g.

In one form of the present invention the graphitic particles of the HSA product have been subject to mechanical exfoliation at greater than 200 kWh/t, for example in the range of 400 to 500 kWh/t, and have a surface area of greater than 20 m²/g, for example 25 to 35 m²/g.

In a further form of the present invention the graphitic particles of the HSA product have been subject to mechanical exfoliation at greater than 700 kWh/t, for example in the range of 1000 to 1200 kWh/t, and have a surface area of greater than 40 m²/g, for example 40 to 50 m²/g.

The drying step to which the HSA product is subjected, is preferably a cryogenic drying method.

Still preferably, the ground primary graphite particles further comprise a carbon-based material. The carbon-based material is preferably one or more of pitch, polyethylene oxide and polyvinyl oxide.

Preferably, the amount of carbon-based material in the secondary graphite particles is in the range of 2 to 10 wt % relative to graphite.

### BRIEF DESCRIPTION OF THE DRAWINGS

The present invention will now be described, by way of example only, with reference to one embodiment thereof and the accompanying drawings, in which:—

FIG. 1 is a scanning electron microscope (SEM) image of a ground primary graphite particle for use in/as used in the method of the present invention, showing magnification at ×2,000 as indicated;

FIG. 2 is a scanning electron microscope (SEM) image of a graphitic material additive for the cathode composition of the present invention, the graphitic material additive comprising an agglomerated fines product, being secondary graphite particles predominantly having a form that approximates an oblate spheroid, showing magnification of ×2,000 as indicated;

FIG. 3 is a scanning electron microscope (SEM) image of a graphitic material additive for the cathode composition of the present invention, the graphitic material additive comprising a high surface area (HSA) product, the HSA product (HSA1) having been subject to mechanical exfoliation to increase the surface area, the surface area being in the range of about 25 to 35 m²/g, showing magnification of ×2,000 as indicated;

FIG. 4 is a scanning electron microscope (SEM) image of a graphitic material additive for the cathode composition of the present invention, the graphitic material additive comprising a high surface area (HSA) product, the HSA product (HSA2) having been subject to mechanical exfoliation to increase the surface area, the surface area being in the range of about 40 to 50 m²/g, showing magnification of ×2,000 as indicated;

FIG. 5 is a graphical representation of the results of experiments to determine the 1^{st} cycle efficiency (FCE/FCL) of a range of cathode compositions, the carbon component being indicated at each bar of the bar chart;

FIG. 6 is a graphical representation of the results of experiments to determine the capacity retention of a range of cathode compositions at 1^{st}, 10^{th} and 15^{th} cycles, measured using coating thickness;

FIG. 7 is a graphical representation of the results of experiments to determine the capacity retention of a range of cathode compositions at 1^{st}, 10^{th} and 15^{th} cycles, measured using coating density; and

FIG. 8 is a cross-sectional view through a single layer laminate cell constructed in known manner, utilising the cathode composition of the present invention to provide a cathode in accordance therewith.

### BEST MODE(S) FOR CARRYING OUT THE INVENTION

The present invention provides a cathode composition, the cathode comprising a graphitic material additive, wherein the graphitic material additive comprises graphitic particles having a generally non-spheroidal form and a D₅₀ of less than about 15 μm, for example less than about 10 μm.

The non-spheroidal form of the graphitic particles is understood to encompass a form that approximates either an oblate spheroid or a flake form.

The graphitic particles have a carbon content of greater than 99.9% wt/wt, for example greater than 99.92% wt/wt.

The graphitic particles comprise either an agglomerated fines product or a high surface area (HSA) product.

The agglomerated fines product comprises secondary graphite particles that predominantly have a form that approximates an oblate spheroid. In one form of the present invention, the secondary graphite particles have a D₅₀ of less than about 5 μm, for example less than about 2 μm.

The secondary graphite particles have a surface area of about 2 to 60 m²/g, for example about 2 to 6 m²/g.

The compression density of the secondary graphite particles at 75 kf/cm² is in the range of about 1.0 to 1.5 g/cc. The conductivity of the secondary graphite particles is in the range of about 25 to 37 S/cm, for example about 31 S/cm.

The secondary graphite particles comprise ground primary graphite particles. The HSA product comprises graphitic particles that have been subject to mechanical exfoliation. This mechanical exfoliation is performed by way of milling, impact, pressure and/or shear forces.

The mechanical exfoliation is conducted:
(i) at greater than 200 kWh/t;
(ii) in the range of 200 to 500 kWh/t;
(iii) at greater than 400 kWh/t;
(iv) in the range of 400 to 500 kWh/t;
(v) at greater than 700 kWh/t;
(vi) in the range of 700 to 1200 kWh/t; or
(vii) in the range of 1000 to 1200 kWh/t.

The graphitic particles of the HSA product have a surface area of:
(i) greater than 20 m²/g.
(ii) in the range of 20 to 40 m²/g.
(iii) in the range of 25 to 35 m²/g;
(iv) greater than 40 m²/g;
(v) in the range of 40 to 80 m²/g; or
(vi) in the range of 40 to 50 m²/g.

The HSA product has a flake form.

The HSA product is also subjected, after mechanical exfoliation, to drying methods that support the retention of its flake form, for example a cryogenic drying method.

In one form of the present invention the graphitic particles of the HSA product have been subject to mechanical exfoliation at greater than 200 kWh/t, for example in the range of 400 to 500 kWh/t, and have a surface area of greater than 20 m²/g, for example 25 to 35 m²/g. This provides what is referred to herein as an HSA product 1, or HSA1.

In a further form of the present invention the graphitic particles of the HSA product have been subject to mechanical exfoliation at greater than 700 kWh/t, for example in the range of 1000 to 1200 kWh/t, and have a surface area of greater than 40 m²/g, for example 40 to 50 m²/g. This provides what is referred to herein as a HSA product 2, or HSA2.

The ground primary graphite particles further comprise a carbon-based material. The carbon-based material is, for example, one or more of pitch, polyethylene oxide and polyvinyl oxide.

The amount of carbon-based material in the secondary graphite particles is in the range of 2 to 10 wt % relative to graphite. The ground primary graphite particles have a DSO:
(i) of less than 15 μm;
(ii) of less than 10 μm; or
(iii) in the range of about 0.5 to 6 μm.

The ground primary graphite particles have a surface area of about 2 to 60 m²/g, for example 7 to 9 m²/g.

The ground primary graphite particles have XRD characteristics of one or more of a d002 of >3.35 Å, an Lc of >1000 Å and an La of >1000 Å. For example, in one form, the ground primary graphite particles have XRD characteristics of each of a d002 of >3.35 Å, an Lc of >1000 Å and an La of >1000 Å, and a purity of >99.9%.

In one form, the secondary graphite particle of the graphitic material additive comprises an aggregate of primary graphite particles, the aggregate providing the approximate oblate spheroid form and having a D₅₀ of less than about 5 microns. The secondary graphite particles may, in one form of the invention, have a D₅₀ of less than about 2 microns.

In one form, the graphitic material additive is derived from a natural graphite precursor.

The present invention further provides a cathode composition comprising a cathode active material, a graphitic material additive, and a binder, wherein the graphitic material additive comprises graphitic particles having a generally non-spheroidal form and a D₅₀ of less than about 15 μm, for example less than about 10 μm.

The non-spheroidal form of the graphitic particles encompasses a form that approximates either an oblate spheroid or a flake form.

In one form of the invention the cathode active material may be provided in the form of lithium cobalt oxide (LCO). In a further form the cathode active material may be provided in the form of nickel manganese cobalt (NMC).

In another form, the binder may be provided in the form of polyvinylidene fluoride (PVdF).

The present invention further provides a lithium-ion battery comprising a cathode composition as described hereinabove. Still further, the present invention provides a method for producing a cathode composition as described hereinabove.

The present invention yet still further provides a method of producing a graphitic material additive for use in a cathode composition, the graphitic material additive having a generally non-spheroidal form and a D₅₀ of less than about 15 μm, for example less than 10 μm, the method comprising the steps of:
(i) Concentrating and purifying a graphite ore to provide primary graphitic particles having a carbon content of greater than 99.9% wt/wt;
(ii) Classifying the concentrated and purified graphitic particles of step
(i) to produce graphite fines;
(iii) Passing the graphite fines of step (ii) to either:
   i. a coating/mixing step followed by a shaping step to produce a coated primary graphite particle, being an agglomerated fines product; or
   ii. a mechanical exfoliation step to increase the surface area of the graphite fines, producing a high surface area (HSA) product, and from which the graphite fines are passed to a drying step, the drying step being one that retains the HSA product in a flake form.

The mechanical exfoliation step is, in one form, performed by way of milling, impact, pressure and/or shear forces. The mechanical exfoliation step is conducted:
(i) at greater than 200 kWh/t;
(ii) in the range of 200 to 500 kWh/t;
(iii) at greater than 400 kWh/t;
(iv) in the range of 400 to 500 kWh/t;
(v) at greater than 700 kWh/t;
(vi) in the range of 700 to 1200 kWh/t; or
(vii) in the range of 1000 to 1200 kWh/t.

The graphitic particles of the HSA product have a surface area of:
(i) greater than 20 m²/g;
(ii) in the range of 20 to 40 m²/g;
(iii) in the range of 25 to 35 m²/g;
(iv) greater than 40 m²/g;
(v) in the range of 40 to 80 m²/g; or
(vi) in the range of 40 to 50 m²/g.

In one form of the present invention the graphitic particles of the HSA product have been subject to mechanical exfoliation at greater than 200 kWh/t, for example in the range of 400 to 500 kWh/t, and have a surface area of greater than 20 m²/g, for example 25 to 35 m²/g.

In a further form of the present invention the graphitic particles of the HSA product have been subject to mechanical exfoliation at greater than 700 kWh/t, for example in the range of 1000 to 1200 kWh/t, and have a surface area of greater than 40 m²/g, for example 40 to 50 m²/g.

The drying step to which the HSA product is subjected, is a cryogenic drying method.

In one form, the ground primary graphite particles further comprise a carbon-based material. The carbon-based material is, for example, one or more of pitch, polyethylene oxide and polyvinyl oxide. The amount of carbon-based material in the secondary graphite particles is in the range of 2 to 10 wt % relative to graphite.

The process of the present invention may be better understood with reference to the following non-limiting examples.

### Ground Primary Graphite Particles

Table A below provides one non-limiting example of an appropriate ground primary graphite particle, a purified graphite fines precursor, for use in/as used in the method of the present invention, whilst Table B provides the elemental analysis thereof.

TABLE A

| Property | Value | | Method |
|---|---|---|---|
| Carbon Content | >99.9% | | LECO (C %, S %). Loss |
| | | | of Ignition (LOI) |
| Surface Area | 2-9 | m²/g | Bernauer-Emmett-Teller (BET) |
| Particle size | 3-15 | μm | Particle size analyzer |
| D₁₀ | 1~3 | μm | |
| D₅₀ | 4~6 | μm | |
| D₉₀ | 7-10 | μm | |
| Bulk Density | 0.2-1 | g/cc | Bulk density apparatus |
| d1002 | >3.35 | Å | XRD |
| Lc | >1000 | Å | |
| La | >1000 | Å | |

TABLE B

| C | Al | Ca | Cu | Fe | K | Mg | Mn | Si | S | ELEMENTS |
|---|---|---|---|---|---|---|---|---|---|---|
| >99.9% | 3.3 | 7.4 | 7.3 | 26.7 | 5.7 | 2.9 | 0.2 | <0.1 | 37 | ppm |

In a preferred form, the purified graphite has a carbon content of >99.9%, preferably >99.92%. Further, the purified graphite has a flake morphology with a particle size distribution with a D₅₀ of less than 20 μm, for example less than 15 μm, and in turn less than 10 μm. Graphite fines are obtained by classifying a feed graphite material.

### Agglomerated Fines Product

In the production of an agglomerated fines product in accordance with one form of the present invention, the ground primary graphite particles are spheronised and coated with a carbon-based material, after which they are pyrolysed, thereby producing the secondary particle that approximates an oblate spheroid. The carbon-based material is one or more of pitch, polyethylene oxide and polyvinyl alcohol. The amount of carbon-based material used in coating the ground primary graphite particles is in the range of 2 to 10 wt % relative to graphite. The temperature of pyrolysis is between about 880° C. to 1100° C. The time for pyrolysis is in the range of about 12 to 40 hours, including both heating and cooling periods.

The present Applicants describe the ground primary graphite particles and their production, in addition to secondary graphite particles of the present invention, in International Patent Application PCT/IB2020/058910, and the entire content thereof is explicitly incorporated herein by reference.

### Example 1

The natural graphite precursor used for the present investigation was extracted from the Vittangi graphite mine in the County of Norrbotten in northern Sweden. This natural graphite source is characterised by hard particles having a very narrow distribution, with microcrystalline flake. The graphite was then chemical purified at the Applicant's pilot plant in Rudolstadt.

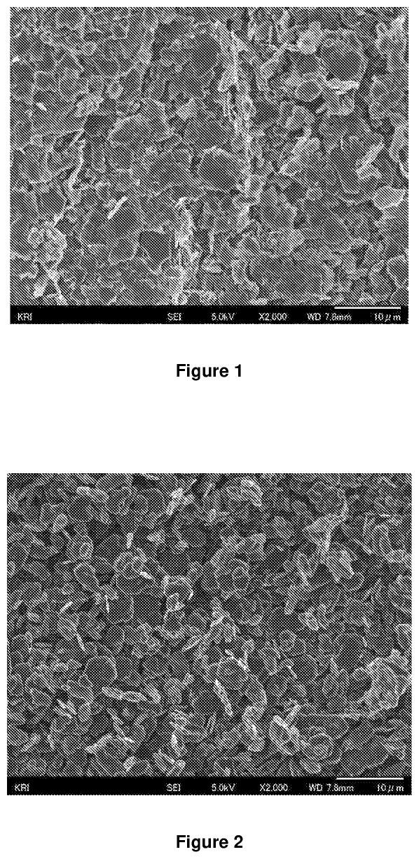

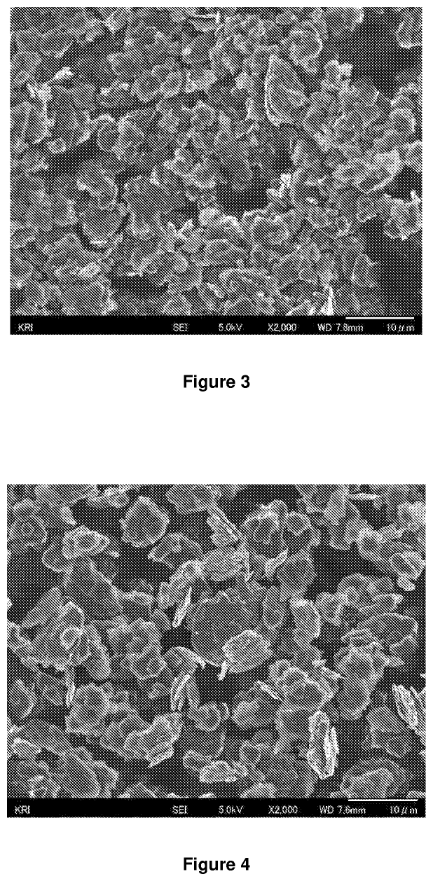

The SEM image of FIG. 1 shows a secondary graphite material comprised of relatively small particles, having a D₅₀ of less than about 5 μm, and smaller ones (of about 1 μm) having a flake shape and they appear to at least partly form agglomerates having a size of about 10 μm.

A series of experiments have been undertaken by or on behalf of the Applicants to investigate the performance of a range of cathode compositions utilising different graphitic material additives.

The cathode composition of cathode active material/binder/graphitic material employed in the conductive additive tests is:

$$LCO / PVdF / Cmix = 95.8 : 1.2 : 3 coin cell$$

LCO designates lithium cobalt oxide, PVdF designates polyvinylidene fluoride, and Cmix represents the particular graphitic material additive employed.

Table 1 shows the range of experiments conducted and the particular graphitic material additive employed.

TABLE 1

| | Cmix (3% of total) |
|---|---|
| Experiment 1 | Carbon Black (CB) |
| Experiment 2 | CB/KS-6 = 2:1 |
| Experiment 3 | HSA |
| Experiment 4 | UHSA |
| Experiment 5 | CB/HSA = 2:1 |
| Experiment 6 | CB/HSA2 = 2:1 |
| Experiment 7 | CB/Agglomerated Fines = 2:1 |

Table 2 provides detail of each of the various graphitic material additives. Various graphitic materials from the Applicant are noted, including T-20 which, as noted hereinafter, are a mix with carbon black in a ratio of 2:1.

TABLE 2

| | Company/ | | Surface | Conductivity | | Chemical |
|---|---|---|---|---|---|---|
| Material | brand name | PSD | area | at 200 MPa | | composition |
| CNT | Timesnano | OD: 50-80 nm, | 80 m2/g | 7.353 | S/cm | purity > 95% |
| | | L:10-15 um | | | | |
| Carbon | TIMCAL C45 | 45 nm | 62 m2/g | 11.317 | S/cm | Purity > 99.9 |
| black (CB) | | | | | | |
| VGCF | Kelu (China) | D 100 nm, L 20-200 um | NA | 2.461 | S/cm | purity > 98% |
| Talphite- | Talga | D10-2.8 microns, | 25 | 1.84 | S/cm | Purity > 99 |
| HSA | | D50- 5.86 microns | | | | |
| | | D90-11.20 microns | | | | |
| Talphite- | Talga | D10-2.6 microns, | 100 | 1.33 | S/cm | Purity > 99 |
| UHSA | | D50- 5.5 microns | | | | |
| | | D90-10.9 microns | | | | |
| T-20 | Talga | D10-1.9 microns, | 5.5 | 9.50 | S/cm | Purity > 99.9 |
| | | D50- 3.8 microns | | | | |
| | | D90-7.2 microns | | | | |
| KS-6 | Timrex | D10-1.5 microns, | 20 | 2.26 | S/cm | Purity > 99.9 |
| | | D50- 3.4 microns | | | | |
| | | D90-6.1 microns | | | | |

The cycling testing steps employed were as follows:

### First Cycle:

(i) Lithiation C/10 to 3V until C/100
(ii) Delithiation C/10 to 4.2V

### Second to Tenth Cycle:

(i) Lithiation C/5 to 3V until C/20
(ii) Delithiation C/5 to 4.2V

### Eleventh to Fifteenth Cycle:

(i) Lithiation 2C to 3V until total lithiation time of 30 minutes
(ii) Delithiation 2C to 42V

The results of experiments 1 and 2 are provided in Table 3 below. References throughout to ‘see attachment’ refer to later Tables in which IR is referenced.

TABLE 3

| | | | | Capacity at | Capacity | | Capacity retention | |
|---|---|---|---|---|---|---|---|---|
| | Coating | Coating | First Cycle | 1^{st} cycle | retention at | | at 15^{th} cycle (fast | |
| | thickness | density | Efficiency | (C/10) | 10^{th} cycle | | charging/discharge) | |
| Expt 1 | (mAh/cm²) | (g/cm³) | (%) | (mAh) | (mAh) | | (mAh) | |
| Cell -A | 2.13 | 2.15 | 97.57% | 3.77 | 3.624 | 96.25% | 2.887 | 79.66% |
| Cell -B | 2.12 | 2.17 | 98.26% | 3.76 | 3.664 | 97.52% | 2.954 | 80.62% |
| Cell -C | 2.04 | 2.24 | 98.27% | 3.61 | 3.435 | 95.10% | 2.779 | 80.90% |

| | | | | Capacity | | | | |
|---|---|---|---|---|---|---|---|---|
| | Coating | | | at 1st | Capacity | | Capacity retention | |
| | thickness | Coating | | cycle | retention at | | at 15th cycle (fast | |
| Expt 2 | (mAh/cm²) | density | FCE | (C/10) | 10th cycle | | charging/discharge) | |
| Cell -A | 2.17 | 2.29 | 98.26% | 3.84 | 3.349 | 87.26% | 2.459 | 73.42% |
| Cell -B | 2.13 | 2.08 | 98.18% | 3.76 | 3.264 | 86.72% | 2.379 | 72.89% |
| Cell -C | 2.21 | 2.20 | 98.33% | 3.91 | 3.574 | 91.50% | 2.581 | 72.22% |

The results of experiments 3 and 4 are provided in Table 4 below.

TABLE 4

| | | | | Capacity | | | | |
|---|---|---|---|---|---|---|---|---|
| | Coating | Coating | | at 1st | Capacity | | Capacity retention | |
| | thickness | density | | cycle | retention at | | at 15th cycle (fast | |
| Expt 3 | (mAh/cm2) | (g/cm3) | FCE | (C/10) | 10th cycle | | charging/discharge) | |
| Cell -A | 1.99 | 2.21 | 97.81% | 3.53 | 3.147 | 89.38% | 0.006 | 0.19% |
| Cell -B | 1.99 | 2.24 | 97.74% | 3.52 | 3.203 | 89.27% | 0 | 0.00% |
| Cell -C | 1.99 | 2.23 | 97.78% | 3.52 | 3.156 | 88.68% | 0.009 | 0.29% |
| | | | | Capacity | | | | |
| | Coating | | | at 1st | Capacity | | Capacity retention | |
| | thickness | Coating | | cycle | retention at | | at 15th cycle (fast | |
| Expt 4 | (mAh/cm2) | density | FCE | (C/10) | 10th cycle | | charging/discharge) | |
| Cell -A | 2.12 | 2.40 | 97.81% | 3.75 | 3.48 | 92.70% | 1.648 | 47.36% |
| Cell -B | 2.10 | 2.42 | 96.38% | 3.72 | 3.451 | 92.79% | 1.468 | 42.54% |
| Cell -C | 2.14 | 2.42 | 98.04% | 3.78 | 3.42 | 90.45% | 1.931 | 56.46% |

The results of experiments 5 and 6 are provided in Table 5 below.

TABLE 5

| | | | | Capacity | | | | |
|---|---|---|---|---|---|---|---|---|
| | Coating | Coating | | at 1st | Capacity | | Capacity retention | |
| | thickness | density | | cycle | retention at | | at 15th cycle (fast | |
| Expt 5 | (mAh/cm2) | (g/cm3) | FCE | (C/10) | 10th cycle | | charging/discharge) | |
| Cell -A | 2.06 | 2.31 | 98.26% | 3.64 | 3.545 | 97.42% | 2.816 | 79.44% |
| Cell -B | 2.09 | 2.26 | 98.18% | 3.71 | 3.611 | 97.38% | 2.865 | 79.34% |
| Cell -C | 2.09 | 2.32 | 98.15% | 3.69 | 3.614 | 97.86% | 2.718 | 75.21% |
| | | | | Capacity | | | | |
| | Coating | | | at 1st | Capacity | | Capacity retention | |
| | thickness | Coating | | cycle | retention at | | at 15th cycle (fast | |
| Expt 6 | (mAh/cm2) | density | FCE | (C/10) | 10th cycle | | charging/discharge) | |
| Cell -A | 2.09 | 2.26 | 98.2% | 3.70 | 3.595 | 97.11% | 2.768 | 77.00% |
| Cell -B | 2.04 | 2.20 | 98.32% | 3.60 | 3.511 | 97.45% | 2.797 | 79.66% |
| Cell -C | 2.10 | 2.26 | 98.35% | 3.71 | 3.364 | 97.39% | 2.595 | 80.07% |

The results of experiment 7 are provided in Table 6 below.

TABLE 6

| | | | | Capacity | | | | |
|---|---|---|---|---|---|---|---|---|
| | Coating | Coating | | at 1st | Capacity | | Capacity retention | |
| | thickness | density | | cycle | retention at | | at 15th cycle (fast | |
| Expt 7 | (mAh/cm2) | (g/cm3) | FCE | (C/10) | 10th cycle | | charging/discharge) | |
| Cell -A | 2.22 | 2.32 | 98.26% | 3.93 | 3.826 | 97.43% | 3.118 | 81.50% |
| Cell -B | 2.22 | 2.34 | 98.31% | 3.94 | 3.832 | 97.31% | 3.114 | 81.26% |
| Cell -C | 2.19 | 2.29 | 98.33% | 3.87 | 3.758 | 97.11% | 3.01 | 80.10% |

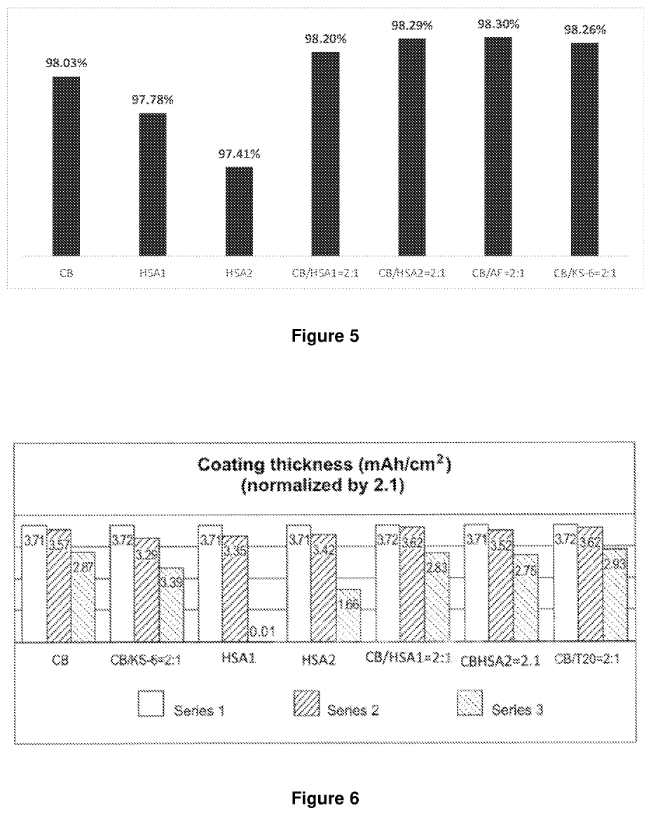

The average data of experiments 1 to 7 is provided in Table 7 below with FCE/FCL represented graphically in FIG. 5 and a capacity retention comparison (coating thickness) shown in FIG. 6.

TABLE 7

| | | | | Capacity at | Capacity | | Capacity retention | |
|---|---|---|---|---|---|---|---|---|
| | Coating | Coating | | 1st cycle | retention at | | at 15th cycle (fast | |
| | thickness | density | | (C/10) | 10th cycle | | charging/discharge) | |
| AVERAGE | (mAh/cm2) | (g/cm3) | FCE | (mAh) | (mAh) | | (mAh) | |
| Expt 1 | 2.10 | 2.18 | 98.03% | 3.71 | 3.57 | 96.29% | 2.87 | 80.40% |
| Expt 2 | 2.17 | 2.18 | 98.26% | 3.84 | 3.40 | 88.49% | 2.47 | 72.84% |
| Expt 3 | 1.99 | 2.23 | 97.78% | 3.52 | 3.17 | 89.11% | 0.01 | 0.16% |
| Expt 4 | 2.12 | 2.41 | 97.41% | 3.75 | 3.45 | 91.98% | 1.68 | 48.79% |
| Expt 5 | 2.08 | 2.30 | 98.20% | 3.68 | 3.59 | 97.55% | 2.80 | 77.99% |
| Expt 6 | 2.08 | 2.24 | 98.29% | 3.67 | 3.49 | 97.31% | 2.72 | 78.91% |
| Expt 7 | 2.21 | 2.32 | 98.30% | 3.91 | 3.81 | 97.28% | 3.08 | 80.95% |

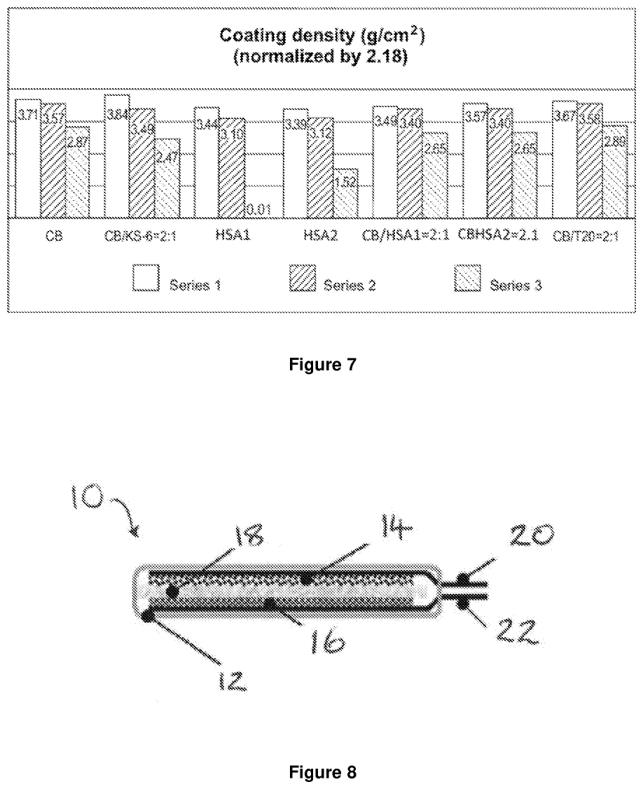

The average data of experiments 1 to 7 is again provided in Table 8 below, with a capacity retention comparison (coating density) shown in FIG. 7.

TABLE 8

| | | | | Capacity at | Capacity | | Capacity retention | |
|---|---|---|---|---|---|---|---|---|
| | Coating | Coating | | 1st cycle | retention at | | at 15th cycle (fast | |
| | thickness | density | | (C/10) | 10th cycle | | charging/discharge) | |
| AVERAGE | (mAh/cm2) | (g/cm3) | FCE | (mAh) | (mAh) | | (mAh) | |
| Expt 1 | 2.10 | 2.18 | 98.03% | 3.71 | 3.57 | 96.29% | 2.87 | 80.40% |
| Expt 2 | 2.17 | 2.18 | 98.26% | 3.84 | 3.40 | 88.49% | 2.47 | 72.84% |
| Expt 3 | 1.99 | 2.23 | 97.78% | 3.52 | 3.17 | 89.11% | 0.01 | 0.16% |
| Expt 4 | 2.12 | 2.41 | 97.41% | 3.75 | 3.45 | 91.98% | 1.68 | 48.79% |
| Expt 5 | 2.08 | 2.30 | 98.20% | 3.68 | 3.59 | 97.55% | 2.80 | 77.99% |
| Expt 6 | 2.08 | 2.24 | 98.29% | 3.67 | 3.49 | 97.31% | 2.72 | 78.91% |
| Expt 7 | 2.21 | 2.32 | 98.30% | 3.91 | 3.81 | 97.28% | 3.08 | 80.95% |

The conclusions drawn by the Applicants from this series of experiments include:
(i) that the order of first cycle efficiency (FCE/FCL) is experiment 4 (HSA2)>experiment 3 (HSA1);
(ii) The capacity retention after 10 cycles at C/5 is worse when only the HSA1 or UHS2 had been used as the additive;
(iii) The mixture of HSA1/UHS2 and CB can improve the FCL and capacity retention; and
(iv) The best performance, including higher conductivity, is realised with agglomerated fines, being a mix with carbon black in a ratio of 2:1 as shown in experiment 7.

Testing was undertaken to investigate the powder resistance, both at similar density after pressure and at similar pressure.

The results of powder resistive testing under similar density after pressure are shown in Table 9 below.

TABLE 9

| | Force | Pressure | Thickness | Resistance | Conductivity | Resistivity | Pressure |
|---|---|---|---|---|---|---|---|
| Sample | (Kg) | (Mpa) | (mm) | (Ω) | (S/cm) | (Ω*cm) | density(g/cm3) |
| HSA1 | 385 | 18.71 | 0.9999 | 0.693772 | 0.071489 | 13.98822 | 1.5146 |
| HSA2 | 338.8 | 16.46 | 1.3377 | 0.695441 | 0.095411 | 10.48101 | 1.5048 |
| Agglom'd | 505.9 | 24.59 | 1.6497 | 0.205498 | 0.398215 | 2.511206 | 1.504 |
| Fines | | | | | | | |
| CNT | unobtainable 1.5 g/cm3 | | | | | | |
| CB | | | | | | | |
| VGCF | 1931.3 | 93.88 | 0.5345 | 0.0231565 | 1.1450276 | 0.8733414 | 1.507 |
| KS-6 | 335.8 | 16.32 | 0.9954 | 0.832055 | 0.0593432 | 16.8511439 | 1.4899 |
| Graphite | 197.2 | 9.58 | 3.288 | 0.452171 | 0.3606952 | 2.7724237 | 1.5074 |

| | |
|---|---|
| LiCoO₂ | NA for 1.5 g/cm3 |

The results of powder resistive testing under similar pressure are shown in Table 10 below.

TABLE 10

| | | | | | | | Pressure |
|---|---|---|---|---|---|---|---|
| | Force | Pressure | Thickness | Resistance | Conductivity | Resistivity | density |
| Sample | (Kg) | (Mpa) | (mm) | (Ω) | (S/cm) | (Q*cm) | (g/cm3) |
| HSA1 | 4115.4 | 200.05 | 0.7105 | 0.0190975 | 1.8454143 | 0.5418838 | 2.1315 |
| HSA2 | 4114 | 199.98 | 0.9474 | 0.0353145 | 1.3307704 | 0.7514444 | 2.1246 |
| Agglom'd | 4115.6 | 200.06 | 1.204 | 0.0062824 | 9.5063542 | 0.1051928 | 2.0607 |
| Fines | | | | | | | |
| CNT | 4116 | 200.08 | 0.3715 | 0.0025063 | 7.3531055 | 0.135997 | 1.3031 |
| CB | 4114.8 | 200.02 | 0.653 | 0.002862 | 11.317147 | 0.0883615 | 1.1995 |
| VGCF | 4115.2 | 200.04 | 0.456 | 0.0091896 | 2.4613071 | 0.4062882 | 1.7666 |
| KS-6 | 4115.7 | 200.06 | 0.6925 | 0.0151851 | 2.2621128 | 0.4420646 | 2.1417 |
| Graphite | 4114.9 | 200.02 | 2.151 | 0.0277732 | 3.8416452 | 0.2603051 | 2.3042 |
| LiCoO₂ | 4118.7 | 200.21 | 2.5186 | 170176.0156 | 0.0000007 | 1362140.52 | 4.1055 |

The Applicants have drawn the following conclusions regarding powder resistance:
(i) At similar density the resistivity is HSA1>HSA2>agglomerated fines; and
(ii) At similar pressure the order is HSA2>HSA1>agglomerated fines.

### Agglomerated Fines and High Surface Area (HSA) Products

The production of the agglomerated fines product is described hereinabove. The production of the high surface area (HSA) products includes a mechanical exfoliation step that can advantageously be carried out using one of milling, impact, pressure, and/or shear forces.

A primary graphite material mechanically exfoliated with 200-500 kWh/t, for example 400-500 kWht/t, energy produces HSA1. The HSA1 product has a surface area of 20 to 40 m²/g, for example 25-35 m²/g.

A primary graphite material mechanically exfoliated with 700 to 1200 kWh/t, for example 1000 to 1200 kWht/t, energy produces HSA2. The HSA2 product has a surface area of 40 to 80 m²/g, for example 40-50 m²/g.

In a preferred form an exfoliated slurry from the mechanical exfoliation step is dried using special drying methods to retain the flake morphology. The special drying method can include a cryogenic drying method. Such a cryogenic method freezes the slurry and sublimates the ice into vapor. An example of suitable process conditions includes the freezing of the slurry into a solid block, followed by subjecting the block to:
(i)<6 mbar vacuum, >0° C. drying temperature, and condenser temperature of <60-70° C.; or
(ii)<1 mbar vacuum, >30-40° C. drying temperature, and condenser temperature of 60-70° C.

The Applicants understand that using typical drying methods, such as a hot air oven, will cause flakes to agglomerate, thereby providing an inferior primary graphite material with relatively reduced surface area.

The particle size of HSA1 and HSA2 are D₅₀ less than 15 μm for example D₅₀ less than 10 μm.

A further series of tests were undertaken by the Applicant to evaluate the Applicant's graphitic material additives compositions in accordance with the present invention in NMC111 cathodes, NMC referencing Nickel Manganese Cobalt.

### Example 2

The details of the agglomerated fines (AF) and high surface area (HSA1 and HSA2) graphitic particles of the composition of the present invention utilised in these tests is set out in Table 11 below.

TABLE 11

| | SAMPLE | | | CHEMICAL | |
|---|---|---|---|---|---|
| Sr. | DETAILS | PARTICLE SIZE | SURFACE AREA | PURITY | MORPHOLOGY |
| 1 | Agglomerated | D50 < 15, preferably | 20-40 m2/g, | >99.9% C | Shaped |
| | fines (AF) | D50 < 10 microns | preferably, 25-35 m2/g | | (ellipsoidal) |
| 2 | HSA1 | D50 < 15, preferably | 20-40 m2/g, | >99.9% C | High surface |
| | | D50 < 10 microns | preferably, 25-35 m2/g | | area flakes |
| 3 | HSA2 | D50 < 15, preferably | 40-80 m2/g, | >99.9% C | High surface |
| | | D50 < 10 microns | preferably, 40-50 m2/g | | area flakes |

The components of the cathode include active material (93 wt. %), Binder/PVDF (3%) and conductive additive (4%). In one test system, the Applicant's graphitic material additives were used as the only additive. In another test system, the Applicant's graphitic material additives were combined with Carbon Black (CB) (reference) in 1:1 ratio (2% each). The CB alone (4%) was used as a reference. The following Table 12 summarises the components of this test system.

TABLE 12

| | |
|---|---|
| Cell type | Single layer Laminate Cell |
| Electrode Type | 50 × 30 mm² |
| Positive electrode | Evaluation sample 2 kind |
| Negative electrode | Standard graphite electrode |
| Separator | PE microporous film |
| Electrolyte | 1M-LiPF6/3EC7MEC |
| Reference pole | NONE |

In FIG. 8 there is shown a full cell 10 incorporating the cathode composition and cathode in accordance with the present invention. The full cell 10 comprises an aluminium laminate film or outer package 12, a negative electrode or anode 14, a positive electrode or cathode 16 in accordance with the present invention, and a separator 18, each arranged in substantially known manner. The anode 14 further comprises a copper current collector 20 and the cathode 16 further comprises an aluminium current collector 22.

Table 13 below provides a summary of the test results in terms of conductivity, coating weight and strength.

TABLE 13

| | HSA1 | HSA1/CB | HSA2 | HSA2/CB | AF | AF/CB | |
|---|---|---|---|---|---|---|---|
| | NCM111:Talga | NCM111:Talga | NCM111:Talga | NCM111:Talga | NCM111:Talga | NCM111:Talga | CB |
| Electrode | Additive:PVDF | Additive:CB:PVDF | Additive:PVDF | Additive:CB:PVDF | Additive:PVDF | Additive:CB:PVDF | NCM111:CB:PVDF |
| Composition | 93:4:3 | 93:2:2:3 | 93:4:3 | 93:2:2:3 | 93:4:3 | 93:2:2:3 | 93:4:3 |
| Electrode | 5.2 × 10⁻³ | 3.3 × 10⁻² | 9.2 × 10⁻³ | 2.7 × 10⁻² | 3.7 × 10⁻⁷ | 4.9 × 10⁻³ | 1.1 × 10⁻² |
| conductivity | | | | | | | |
| (S/cm) | | | | | | | |
| Coating | 21.5 | 21.4 | 21.5 | 21.2 | 21 | 21.4 | 21.5 |
| weight | | | | | | | |
| (mg/cm2) | | | | | | | |
| Strength test | PASS | PASS | PASS | PASS | PASS | PASS | PASS |
| (Winding, | | | | | | | |
| Powder fall | | | | | | | |
| test, | | | | | | | |
| Impreg- | | | | | | | |
| nation) | | | | | | | |

Conductivity values of electrodes (Electrode conductivity S/cm) with HSA1 and HSA2 in 1:1 ratio with CB was higher (3×) than reference alone. It is believed that this result may indicate that a relatively smaller amount of conductive agent can be added (less than 4 wt. % for example in this case) to achieve a required conductivity, and a higher amount of active cathode material can be added which will in turn increase battery capacity.

Calender density of electrodes with Applicant's graphitic material additives was higher compared to reference. Calendering can be defined as compressing of dried electrode material to reduce porosity, improve particle contacts and enhance the energy density. At the same applied calender pressure, Applicant's graphitic material additive containing electrode achieved higher densities. It is believed that this result may indicate that electrodes prepared with the cathode composition of the present invention can be compressed more/occupy smaller volume, and therefore the volumetric energy density will increase relative to the prior art. At a macroscale, this is understood to indicate relatively smaller/lighter batteries for the same drive length. Table 14 below summarises the calenderability and electrochemical cycling of respective graphitic material additives.

TABLE 14

| | Electrode | Electrochemical cycling (About 2.9 g/cc calender density) | | | | | | |
|---|---|---|---|---|---|---|---|---|
| | Calenderability | 1st cycle | | | | | | |
| | (Electrode | charging | 1st cycle | % 1st cycle | 3rd cycle | 3rd cycle | | |
| | density at | capacity | discharging | Efficiency | charging | discharging | % 3rd cycle | % 100 cycle |
| | 1.4 KN/cm) | % | % | % | % | % | Efficiency | Efficiency |
| AF/CB | 101.58 | 98.87 | 98.46 | 99.53 | 98.46 | 99.11 | 100.40 | 97.51 |
| HSA1 | 105.86 | 99.25 | 98.90 | 99.53 | 98.90 | 99.56 | 100.40 | 97.94 |
| HSA1/CB | 103.19 | 98.68 | 98.46 | 99.77 | 98.24 | 99.11 | 100.71 | 96.97 |
| HSA2 | 104.54 | 98.11 | 97.80 | 99.65 | 97.80 | 98.44 | 100.50 | 97.94 |
| HSA2/CB | 104.64 | 96.98 | 96.48 | 99.42 | 96.26 | 97.11 | 100.50 | 98.59 |
| CB | 100.00 | 100.00 | 100.00 | 100.00 | 100.00 | 100.00 | 100.00 | 100.00 |

All electrochemical performance properties were consistent with (within experimental variation) the reference system. This indicates the Applicant's graphitic material additives do not have any untoward effect towards the active cathode material performance. All values are % of reference (CB alone).

Modifications and variations such as would be apparent to the skilled addressee are considered to fall within the scope of the present invention.

1-40. (canceled)

41. A cathode composition, the cathode composition comprising a graphitic material additive, wherein the graphitic material additive comprises graphitic particles having a generally non-spheroidal form and a D₅₀ of less than about 15 μm, optionally less than about 10 μm.

42. The cathode composition of claim 41, wherein the non-spheroidal form of the graphitic particles encompasses a form that approximates either an oblate spheroid or a flake form.

43. The cathode composition of claim 41, wherein the graphitic particles have a carbon content of:
(i) greater than 99.9% wt/wt; or
(ii) greater than 99.92% wt/wt.

44. The cathode composition of claim 41, wherein the graphitic particles comprise either an agglomerated fines product or a high surface area (HSA) product, the HSA product optionally being provided in flake form, and wherein the agglomerated fines product comprises secondary graphite particles, optionally comprising ground primary graphite particles, the secondary graphite particles predominantly having a form that approximates an oblate spheroid, the secondary graphite particles having a D₅₀ of:
(i) less than about 5 μm; or
(ii) less than about 2 μm.

45. The cathode composition of claim 44, wherein the secondary graphite particles have a surface area (BET) of:
(i) about 2 to 60 m²/g; or
(ii) about 2 to 6 m²/g.

46. The cathode composition of claim 44, wherein the compression density of the secondary graphite particles at 75 kf/cm² is in the range of about 1.0 to 1.5 g/cc.

47. The cathode composition of claim 44, wherein the conductivity of the secondary graphite particles is:
(i) in the range of about 25 to 37 S/cm; or
(ii) about 31 S/cm.

48. The cathode composition of claim 44, wherein the HSA product comprises graphitic particles that have been:
(i) subject to mechanical exfoliation; or
(ii) subject to mechanical exfoliation performed by way of milling, impact, pressure and/or shear forces.

49. The cathode composition of claim 44, wherein the HSA product comprises graphitic particles that have been subject to mechanical exfoliation, and the mechanical exfoliation is conducted:
(i) at greater than 200 kWh/t;
(ii) in the range of 200 to 500 kWh/t;
(iii) at greater than 400 kWh/t;
(iv) in the range of 400 to 500 kWh/t;
(v) at greater than 700 kWh/t;
(vi) in the range of 700 to 1200 kWh/t; or
(vii) in the range of 1000 to 1200 kWh/t.

50. The cathode composition of claim 44, wherein the HSA product comprises graphitic particles that have been subject to mechanical exfoliation, and the graphitic particles of the HSA product have a surface area (BET) of:
(i) greater than 20 m²/g;
(ii) in the range of 20 to 40 m²/g;
(iii) in the range of 25 to 35 m²/g;
(iv) greater than 40 m²/g;
(v) in the range of 40 to 80 m²/g; or
(vi) in the range of 40 to 50 m²/g.

51. The cathode composition of claim 44, wherein the HSA product has the flake form and the HSA product is also subjected, after mechanical exfoliation, to:
(i) drying methods that support the retention of its flake form; or
(ii) a cryogenic drying method.

52. The cathode composition of claim 44, wherein the secondary graphite particles comprise ground primary graphite particles, and the ground primary graphite particles further comprise:
(i) a carbon-based material; or
(ii) one or more of pitch, polyethylene oxide and polyvinyl oxide.

53. The cathode composition of claim 44, wherein the secondary graphite particles comprise ground primary graphite particles, and the amount of carbon-based material in the secondary graphite particles is in the range of 2 to 10 wt % relative to graphite.

54. The cathode composition of claim 44, wherein the secondary graphite particles comprise ground primary graphite particles, and the ground primary graphite particles have a D₅₀:
(i) of less than 15 μm;
(ii) of less than 10 μm; or
(iii) in the range of about 0.5 to 6 μm.

55. The cathode composition of claim 44, wherein the secondary graphite particles comprise ground primary graphite particles, and the ground primary graphite particles:
(i) have a surface area (BET) of about 2 to 60 m²/g;
(ii) have a surface area (BET) of about 7 to 9 m²/g;
(iii) have XRD characteristics of one or more of a d002 of >3.35 Å, an Lc of >1000 Å and an La of >1000 Å; and/or
(iv) have XRD characteristics of each of a d002 of >3.35 Å, an Lc of >1000 Å and an La of >1000 Å, and a purity of >99.9%.

56. The cathode composition of claim 44, wherein the secondary graphite particle of the graphitic material additive, optionally derived from a natural graphite precursor, comprises an aggregate of primary graphite particles, the aggregate providing the approximate oblate spheroid form and having a D₅₀ of:
(i) less than about 5 microns; or
(ii) less than about 2 microns.

57. A cathode composition comprising a cathode active material, a graphitic material additive, and a binder, the binder optionally being provided in the form of polyvinylidene fluoride (PVdF), wherein the graphitic material additive comprises graphitic particles having a generally non-spheroidal form, optionally either in a form that approximates an oblate spheroid or in a flake form, and having a D₅₀ of:
(i) less than about 15 μm; or
(ii) less than about 10 μm.

58. The cathode composition of claim 57, wherein the cathode active material is provided in the form of lithium cobalt oxide (LCO) or nickel manganese cobalt (NMC).

59. A lithium-ion battery comprising the cathode composition as described in claim 41.

60. A method for producing the cathode composition as described in claim 41.
